(19) United States
(12) Patent Application Publication
(10) Pub. No.: US 2017/0244677 A1
(43) Pub. Date: Aug. 24, 2017

(54) OPERATION METHOD BASED ON WHITE-BOX CRYPTOGRAPHY AND SECURE TERMINAL FOR PERFORMING THE METHOD

(71) Applicants: ELECTRONICS AND TELECOMMUNICATIONS RESEARCH INSTITUTE, Daejeon (KR); Hancom Secure Inc., Seongnam (KR)

(72) Inventors: Seung Kwang LEE, Daejeon (KR); You Sung KANG, Daejeon (KR); Ju Han KIM, Daejeon (KR); Tae Sung KIM, Daejeon (KR); Doo Ho CHOI, Cheonan (KR); Geon Woo KIM, Daejeon (KR); Soo Hyung KIM, Daejeon (KR); Hyun Sook CHO, Daejeon (KR); Seung Hun JIN, Daejeon (KR)

(21) Appl. No.: 15/214,309

(22) Filed: Jul. 19, 2016

(30) Foreign Application Priority Data
Feb. 18, 2016 (KR) 10-2016-0019360

(51) Int. Cl. H04L 29/06; H04L 9/08

(52) U.S. Cl. CPC H04L 63/0428; H04L 9/0816

(57) ABSTRACT

Provided are an operation method and a secure terminal for performing the method. The operation method may include receiving, from a user terminal, a plain text on which an external encoding operation is to be performed, performing the external encoding operation on the plain text, and transmitting the external encoding operated plain text to the user terminal, and the operation method may include receiving, from a user terminal, a cryptogram in which a white-box cryptography operation is performed on an external encoding operated plain text; performing an external decoding operation on the cryptogram; and transmitting the external decoding operated cryptogram to the user terminal.

### CROSS-REFERENCE TO RELATED APPLICATION(S)

This application claims the priority benefit of Korean Patent Application No. 10-2016-0019360 filed on Feb. 18, 2016, in the Korean Intellectual Property Office, the disclosure of which is incorporated herein by reference for all purposes.

### BACKGROUND

1. Field

One or more example embodiments relate to an operation method based on white- box cryptography and a secure terminal for performing the method, and more particularly, to a method of coping with exploit of a lookup table according to a white-box cryptography operation and a terminal for performing the method.

2. Description of Related Art

White-box cryptography is a method that realizes technology for protecting a software content copyright, that is, technology for preventing an illegal distribution. In detail, the white-box cryptography relates to a method of mixing cryptographic key information with a software cryptographic algorithm to prevent inference of a cryptographic key of a cryptographic algorithm. The white-box cryptography may prevent a cryptographic key from being easily inferred although an attacker analyzes an internal algorithm operation.

That is, in the white-box cryptography, since the cryptographic key is mixed with the software cryptographic algorithm, the attacker may not readily distinguish the cryptographic algorithm from the cryptographic key even after succeeding in analyzing the internal algorithm operation. To this end, the white-box cryptography may perform an operation on the cryptographic algorithm using a lookup table for encoding.

Here, if a lookup table according to the white-box cryptography is exploited by the attacker, the attacker may expose information associated with the white-box cryptography operation using the exploited lookup table. That is, the lookup table is coupled with a secret key about the cryptographic algorithm. Thus, if the lookup table is exploited by the attacker, the attacker may acquire desired information using a secret key included in the exploited lookup table.

That is, the attacker may interpret and infer a cryptographic key by finding out all of a cryptography operation process and an intermediate value using the lookup table and may acquire information accordingly.

Accordingly, there is a need for a method that may prevent leakage of information although a lookup table according to a white-box cryptography operation is exploited by an attacker.

### SUMMARY

An aspect of example embodiments provides a method that may prevent leakage of information by an external attacker although a lookup table according to a white-box cryptography operation is exploited by the external attacker.

According to an aspect of example embodiments, there is provided an operation method performed at a secure terminal, the method including receiving, from a user terminal, a plain text on which an external encoding operation is to be performed; performing the external encoding operation on the plain text using a security table for external encoding; and transmitting the external encoding operated plain text to the user terminal. The user terminal performs a white-box cryptography operation that includes a plurality of encoding operations, a decoding operation, and a cryptography operation on the external encoding operated plain text.

The plain text on which the external encoding operation is to be performed may indicate data to be decoded through the user terminal.

The performing of the external encoding operation may include performing linear or nonlinear encoding on the plain text on which the external encoding operation is to be performed.

The user terminal may not include the security table for external encoding among lookup tables for the white-box cryptography operation.

According to another aspect of example embodiments, there is provided an operation method performed at a secure terminal, the method including receiving, from a user terminal, a cryptogram in which a white-box cryptography operation is performed on an external encoding operated plain text; performing an external decoding operation corresponding to an external encoding operation on the cryptogram using a security table for external encoding; and transmitting the external decoding operated cryptogram to the user terminal. The user terminal displays the external decoding operated cryptogram.

The plain text on which the external encoding operation is to be performed may indicate data to be decoded through the user terminal.

The external encoding operation may be performed on the plain text on which the external encoding operation is to be performed, based on linear or nonlinear encoding.

The receiving of the cryptogram in which the white-box cryptography operation is performed may include performing the white-box cryptography operation that includes a plurality of encoding operations, a decoding operation, and an cryptography operation on the external encoding operated plain text, and receiving the cryptogram in which the white-box cryptography operation is performed.

The performing of the external decoding operation may include performing, at the secure terminal, a decoding operation on the cryptogram that is acquired by performing the white-box cryptography operation that includes a plurality of encoding operations, a decoding operation, and a cryptography operation on the external encoding operated plain text.

According to another aspect of example embodiments, there is provided an operation method performed at a secure terminal, the method including receiving an external encoding operated plain text from a user terminal; performing a white-box cryptography operation that includes a plurality of encoding operations, a decoding operation, and a cryptography operation on the external encoding operated plain text; and transmitting the white-box cryptography operated plain text to the user terminal. The user terminal displays the white-box cryptography operated plain text.

The external encoding operated plain text may indicate a result of performing, at the user terminal, the external encoding operation on the plain text using a security table for external encoding.

The performing of the white-box encoding operation may include performing the white-box cryptography operation on the external encoding operated plain text using an encoding/decoding table among lookup tables for the white-box cryptography operation.

An operation method according to example embodiments may manage a security table for external encoding in a separate cryptographic device, thereby preventing leakage of information against exploit of a lookup table by an external attacker.

An operation method according to example embodiments may perform a white-box cryptography operation based on a result value of an external encoding/decoding operation performed on a plain text or a cryptogram using a separate cryptographic device and may output an accurate cryptogram/decrypted text using the result value obtained from the separate cryptographic device.

An operation method according to example embodiments may perform an external encoding/decoding operation and, if necessary, may also perform a white-box cryptography operation using a separate cryptographic device and thus, may separately manage an operation that requires the security of information.

Additional aspects of example embodiments will be set forth in part in the description which follows and, in part, will be apparent from the description, or may be learned by practice of the disclosure.

### BRIEF DESCRIPTION OF THE DRAWINGS

These and/or other aspects, features, and advantages of the invention will become apparent and more readily appreciated from the following description of example embodiments, taken in conjunction with the accompanying drawings of which:

FIG. 1 is a diagram illustrating a configuration of a white-box cryptography operation according to an example embodiment;

FIG. 2 illustrates an example of a lookup table based on a white-box cryptography operation according to an example embodiment;

FIG. 3 is a flowchart illustrating an operation method based on white-box cryptography according to an example embodiment; and

FIG. 4 is a flowchart illustrating an operation method based on white-box cryptography according to another example embodiment.

### DETAILED DESCRIPTION

Hereinafter, some example embodiments will be described in detail with reference to the accompanying drawings. Regarding the reference numerals assigned to the elements in the drawings, it should be noted that the same elements will be designated by the same reference numerals, wherever possible, even though they are shown in different drawings. Also, in the description of embodiments, detailed description of well-known related structures or functions will be omitted when it is deemed that such description will cause ambiguous interpretation of the present disclosure.

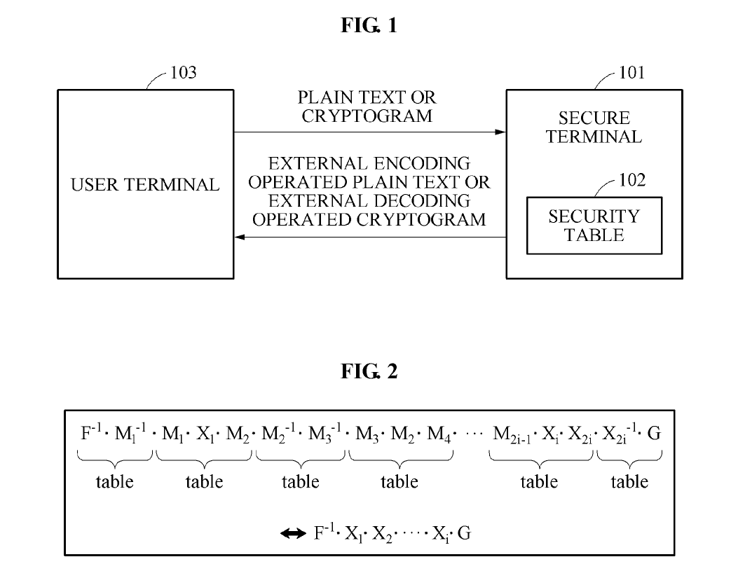

FIG. 1 is a diagram illustrating a configuration of a white-box cryptography operation according to an example embodiment.

Referring to FIG. 1, a user terminal 103 may transfer, to a secure terminal 101, a plain text or a cryptogram on which a white-box cryptography operation is to be performed. Here, the user terminal 103 may be a terminal that performs the white-box cryptography operation by including a lookup table for an encoding/decoding operation according to the white-box cryptography operation. That is, the user terminal 103 may include a storage medium capable of storing the lookup table and may perform the encoding/decoding operation according to the white-box cryptography operation using the lookup table included in the storage medium. For example, the user terminal 103 may be a desktop, a tablet personal computer (PC), a laptop computer, and the like, capable of performing the white-box cryptography operation, and may include any type of devices that include a storage function and an operation function.

Here, an operation method proposed herein may manage a security table 102 among lookup tables in the separate the secure terminal 101 such that an external encoding/decoding operation in the white-box cryptography operation may be performed into consideration of a case in which lookup data including a secret key is exploited by an attacker. That is, if a lookup table including a secret key is stored in the user terminal 103, a risk of exploit may increase. The proposed operation method may manage the security table 102 corresponding to external encoding/decoding in lookup data in the secure terminal 101, and may enable external encoding/decoding to be performed at the secure terminal 101.

Accordingly, the user terminal 103 may perform the white-box cryptography operation using the secret key included in the lookup table. Here, the user terminal 103 may transfer the plain text or the cryptogram on which the white-box cryptography operation is to be performed to the secure terminal 101 such that the secure terminal 101 may perform the external encoding/decoding operation on the plain text or the cryptogram. Here, the user terminal 103 may include a remaining encoding/decoding table excluding the security table 102 for external encoding/decoding from the lookup tables according to the white-box cryptography operation. The secure terminal 101 may include the security table 102 for external encoding/decoding in the lookup tables.

The secure terminal 101 may receive, from the user terminal 103, the plain text or the cryptogram on which the white-box cryptography operation is to be performed. The secure terminal 101 may perform external encoding or external decoding based on data received from the user terminal 103.

(1) A case in which the plain text is received:

The secure terminal 101 may receive, from the user terminal 103, the plain text on which the external encoding operation is to be performed. The secure terminal 101 may perform the external encoding operation on the plain text using the security table 102 for external encoding. Here, the secure terminal 101 may perform linear or nonlinear encoding on the plain text. The secure terminal 101 may transmit the external encoding operated plain text to the user terminal 103.

The user terminal 103 may perform, on the external encoding operated plain text, a white-box cryptography operation that includes a plurality of encoding operations, a decoding operation, and a cryptography operation.

(2) A case in which the cryptogram is received:

The secure terminal 101 may receive, from the user terminal 103, the cryptogram in which the white-box cryptography operation is performed on the external encoding operated plain text. The secure terminal 101 may perform a decoding operation corresponding to the external encoding operation on the cryptogram using the security table 102 for external encoding.

That is, the secure terminal 101 may decode again the cryptogram that is obtained by performing the white-box cryptography operation that includes the plurality of encoding operations, the decoding operation, and the cryptography operation on the external encoding operated plain text. The secure terminal 101 may transmit the decoded cryptogram to the user terminal 103. The user terminal 103 may display the decoded cryptogram on a display.

The operation method according to an example embodiment may transmit the external encoding operated plain text to the user terminal 103 in response to the plain text received from the user terminal 103, based on a challenge-response for coping with exploit of a white-box security table. That is, an operation of receiving, at the secure terminal 101, the plain text or the cryptogram from the user terminal 103 may be defined as a challenge operation. An operation of transmitting the external encoding operated plain text or the external decoding operated cryptogram to the user terminal 103 may be defined as a response operation.

The operation method performed at the secure terminal 101 may perform the white-box cryptography operation by performing the external encoding/decoding operation and by performing an intermediate encoding/decoding operation. That is, the user terminal 103 may perform the external encoding operation on the plain text on which the external encoding operation is to be performed and the secure terminal 101 may perform the white-box cryptography operation on the external encoding operated plain text. The secure terminal 101 may transmit the white-box cryptography operated plain text to the user terminal 103, and the user terminal 103 may provide a complete cryptogram/decrypted text to the user based on the white-box cryptography operated plain text received from the secure terminal 101.

According to example embodiments, the operation method may apply a challenge-response to a plain text and a cryptogram in order to configure a correct cryptogram/decrypted text according to a white-box cryptography operation.

To acquire a correction operation value based on the white-box cryptography operation according to the operation method, a complete cryptogram/decrypted text may not be easily configured using only an encoding/decoding table stored in the user terminal 103. That is, the operation method may configure the complete cryptogram/decrypted text based on the white-box cryptography operation by performing the external encoding/decoding process on the plain text or the cryptogram using the secure terminal 101 and by performing the white-box cryptography operation on the external encoding/decoding operated plain text using the user terminal 103.

FIG. 2 illustrates an example of a lookup table based on a white-box cryptography operation according to an example embodiment.

FIG. 2 illustrates a cryptographic result value in a lookup table on which encoding according to the white-box cryptography operation is performed.

In general, a white-box model indicates an environment in which an attacker is accessible to every resource, such as a memory, a register, and the like. The white-box cryptography operation relates to an operation method of preventing leakage of an intermediate value of a cryptography operation by reconfiguring an cryptographic algorithm as a consecutive lookup table and by encoding the lookup table.

Here, the lookup table on which encoding according to the white-box cryptography operation is performed may be represented as Table 2. The white-box cryptography operation may be generated as a single large lookup table with respect to a cryptographic algorithm and thus, may easily hide a cryptographic key. However, a table size may significantly increase. Accordingly, the white-box cryptography operation may prevent an intermediate value of the cryptographic algorithm from being exposed by applying a cryptographic scheme to a table, and may appropriately perform an encoding operation and a decoding operation.

Here, the encoding operation and the decoding operation are performed in separate tables. Thus, without exposing an intermediate value of the cryptographic algorithm, encoding and decoding may be offset and a result of performing only an original cryptography operation may be acquired.

The white-box cryptography operation may add an external encoding process and an external decoding process based on cryptographic stability of the cryptographic algorithm. Accordingly, the added external encoding process and external decoding process may be performed in separate secure terminals, respectively, instead of being operated in a single device. Thus, the security of the cryptographic algorithm may be enhanced.

In the related art, if a user terminal that stores a lookup table associated with a white-box cryptography operation is exploited by an attacker, the attacker may own the lookup table stored in ROM or a disk and may perform an encoding/decoding operation using the lookup table. Here, since a secret key is coupled with the lookup table, the white-box cryptography operation by exploit may be possible.

In this regard, according to a configuration of example embodiments, a user terminal may be a separate device instead of owning a security table capable of performing an external encoding/decoding operation. The external encoding/decoding may be performed operation on a plain text or a cryptogram using a secure terminal. The user terminal may output a correct cryptogram/decrypted text based on the external encoding/decoding operated plain text or cryptogram only when the encoding/decoding process according to the white-box cryptography operation is performed.

According to example embodiments, since it may be difficult to output a complete cryptogram/decrypted text using only an encoding/decoding table stored in a user terminal and it may be possible to output the complete cryptogram/decrypted text only when using all of a security table stored in a secure terminal and the encoding/decoding table stored in the user terminal, it is possible to perform a security correspondence against exploit of a lookup table.

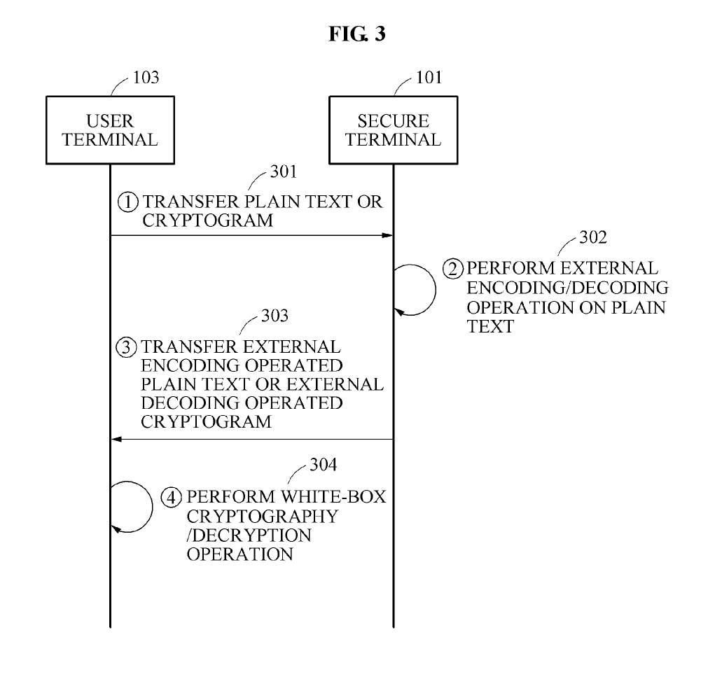

FIG. 3 is a flowchart illustrating an operation method based on white-box cryptography according to an example embodiment.

In operation 301, the user terminal 103 may transfer, to the secure terminal 101, a plain text or a cryptogram on which an external encoding operation is to be performed.

(1) In case of transferring the plain text:

The plain text may indicate data to be decoded through the user terminal 103. For example, ‘F’ denotes a process of encoding a plain text to be decoded through and may indicate an external encoding operation in principles of white-box cryptography operation.

The user terminal 103 may transfer, to the secure terminal 101, the plain text on which the external encoding operation according to the white-box cryptography operation is to be performed.

(2) In case of transferring the cryptogram:

The cryptogram may indicate data in which the white-box cryptography operation is performed on the external encoding operated plain text. For example, ‘G⁻¹’ may indicate an external decoding operation of decoding again an external encoded result through a final process of the white-box cryptography operation. Here, the cryptogram may indicate a final result obtained by performing the white-box cryptography operation that includes a plurality of encoding operations, a decoding operation, and a cryptography operation according to a cryptographic algorithm through the user terminal 103.

The user terminal 103 may transfer, to the secure terminal 101, the cryptogram in which the white-box cryptography operation is performed on the external encoding operated plain text.

In operation 302, the secure terminal 101 may perform the external encoding operation or the external decoding operation based on features of data received from the user.

(1) In the case of receiving the plain text:

The secure terminal 101 may perform the external encoding operation on the plain text using a security table for external encoding. Here, the secure terminal 101 may perform linear or nonlinear encoding on the plain text on which the external encoding operation is to be performed.

Linear Encoding:

The secure terminal 101 may perform linear encoding on the plain text. In detail, a linear encoding method may be an encoding method of multiplying invertible matrices.

Nonlinear Encoding:

The secure terminal 101 may perform nonlinear encoding on the plain text. In detail, a nonlinear encoding method may be an encoding method of replacing an operation function, such as a SubBytes operation of an advanced encryption standard (AES) cryptographic algorithm, with a predetermined number.

(2) In case of receiving the cryptogram:

The secure terminal 101 may perform a decoding operation corresponding to the external encoding operation on the cryptogram using the security table for external encoding.

That is, the secure terminal 101 may perform the external decoding operation for decoding again the external encoded result through a final process of the white-box cryptography operation.

In operation 303, the secure terminal 101 may transmit the external decoding operated cryptogram or the external encoding operated plain text to the user terminal 103.

In operation 304, the user terminal 103 may perform the following process on the external decoding operated cryptogram or the external encoding operated plain text received from the secure terminal 101.

(1) In the case of receiving the external encoding operated plain text:

The user terminal 103 may perform the white-box cryptography operation that includes a plurality of encoding operations, a decoding operation, and a cryptography operation on the external encoding operated text. That is, the user terminal 103 may perform the white-box cryptography operation on the external encoding operated plain text by applying ‘F ⁻¹’ corresponding to the external encoding operated plain text.

(2) In the case of receiving the external decoding operated cryptogram:

The user terminal 103 may display the external decoding operated cryptogram on a display. That is, the user terminal 103 may receive a result of decoding again an external encoding value through a final process of the white-box cryptography operation, and may display the result received from the secure terminal 101 on a screen of the user terminal 103 or may store and manage the received result in a storage medium.

If all of the lookup tables for the white-box cryptography/decryption operation are stored in a single storage device, a risk of exploit may increase. According to an example embodiment, since F or G⁻¹ corresponding to external encoding/decoding in principles of white-box cryptography operation may be performed using a separate device, it is possible to prevent leakage of information by exposing of a lookup table.

That is, according to an example embodiment, the user terminal 103 may own only the encoding/decoding table instead of owning the security table capable of performing the external encoding/decoding operation. The security table may be owned at the secure terminal 101 and the external encoding/decoding operation may be separately performed at the secure terminal 101 that owns the security table. Thus, an accurate cryptogram/decrypted text may be output only when encryption/decryption according to the white-box cryptography operation is performed based on a result value of the external encoding/decoding operation performed at the secure terminal 101.

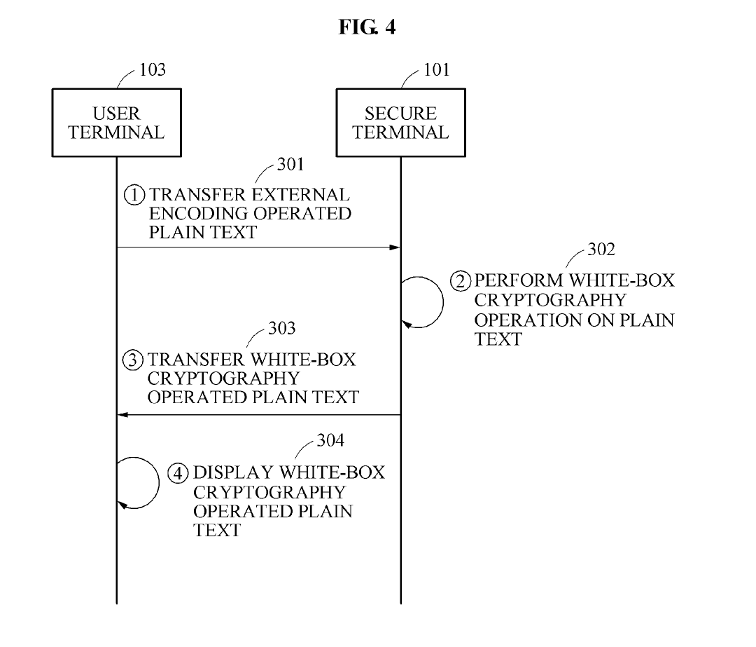

FIG. 4 is a flowchart illustrating an operation method based on white-box cryptography according to another example embodiment.

In operation 401, the user terminal 103 may perform an external encoding operation on a plain text. In detail, the user terminal 103 may perform linear or nonlinear encoding on the plain text that indicates data to be decoded. The user terminal 103 may include a security table for external encoding in lookup tables for a white-box cryptography operation, and may not include an encoding/decoding table for the white-box cryptography operation.

The user terminal 103 may perform the external encoding operation on the plain text using the security table for external encoding. The user terminal 103 may transfer the external encoding operated plain text to the secure terminal 101.

In operation 402, the secure terminal 101 may receive the external encoding operated plain text. The secure terminal 101 may perform the white-box cryptography operation that includes a plurality of encoding operations, a decoding operation, and a cryptography operation on the external encoding operated plain text. That is, the secure terminal 101 may perform the white-box cryptography operation on the external encoding operated plain text by applying ‘F⁻¹’ corresponding to the external encoding operated plain text.

In operation 403, the secure terminal 101 may transfer the white-box cryptography operated plain text to the user terminal 103.

In operation 404, the user terminal 103 may display a result of the white-box cryptography operated plain text received from the secure terminal 101 on a screen of the user terminal 103, or may store and manage the result in a storage medium.

As described above, according to example embodiments, in addition to performing F or G⁻¹ corresponding to an external encoding/decoding operation in principles of white-box cryptography operation using a separate device, it is possible to perform one of operations in the principles using a separate device. Accordingly, it is possible to prevent leakage of information by exposing of a lookup table.

That is, in an operation performed at the secure terminal 101, it is possible to perform external encoding through nonlinear and linear encoding. In addition, it is possible to expand to other operations. Accordingly, it is possible to enforce the security about a lookup table by exploit risk or important data from another user

The methods according to the above-described example embodiments may be recorded in non-transitory computer-readable media including program instructions to implement various operations of the above-described example embodiments. The media may also include, alone or in combination with the program instructions, data files, data structures, and the like. The program instructions recorded on the media may be those specially designed and constructed for the purposes of example embodiments, or they may be of the kind well-known and available to those having skill in the computer software arts. Examples of non-transitory computer-readable media include magnetic media such as hard disks, floppy disks, and magnetic tape; optical media such as CD-ROM discs, DVDs, and/or Blue-ray discs; magneto-optical media such as optical discs; and hardware devices that are specially configured to store and perform program instructions, such as read-only memory (ROM), random access memory (RAM), flash memory (e.g., USB flash drives, memory cards, memory sticks, etc.), and the like. Examples of program instructions include both machine code, such as produced by a compiler, and files containing higher level code that may be executed by the computer using an interpreter. The above-described devices may be configured to act as one or more software modules in order to perform the operations of the above-described example embodiments, or vice versa.

A number of example embodiments have been described above. Nevertheless, it should be understood that various modifications may be made to these example embodiments. For example, suitable results may be achieved if the described techniques are performed in a different order and/or if components in a described system, architecture, device, or circuit are combined in a different manner and/or replaced or supplemented by other components or their equivalents. Accordingly, other implementations are within the scope of the following claims.

What is claimed is:

1. An operation method performed at a secure terminal, the method comprising:
receiving, from a user terminal, a plain text on which an external encoding operation is to be performed;
performing the external encoding operation on the plain text using a security table for external encoding; and
transmitting the external encoding operated plain text to the user terminal,
wherein the user terminal performs a white-box cryptography operation that includes a plurality of encoding operations, a decoding operation, and a cryptography operation on the external encoding operated plain text.

2. The method of claim 1, wherein the plain text on which the external encoding operation is to be performed indicates data to be decoded through the user terminal.

3. The method of claim 1, wherein the performing of the external encoding operation comprises performing linear or nonlinear encoding on the plain text on which the external encoding operation is to be performed.

4. The method of claim 1, wherein the user terminal does not include the security table for external encoding among lookup tables for the white-box cryptography operation.

5. An operation method performed at a secure terminal, the method comprising:
receiving, from a user terminal, a cryptogram in which a white-box cryptography operation is performed on an external encoding operated plain text;
performing an external decoding operation corresponding to an external encoding operation on the cryptogram using a security table for external encoding; and
transmitting the external decoding operated cryptogram to the user terminal,
wherein the user terminal displays the external decoding operated cryptogram.

6. The method of claim 5, wherein the plain text on which the external encoding operation is to be performed indicates data to be decoded through the user terminal.

7. The method of claim 5, wherein the external encoding operation is performed on the plain text on which the external encoding operation is to be performed, based on linear or nonlinear encoding.

8. The method of claim 5, wherein the receiving of the cryptogram in which the white-box cryptography operation is performed comprises performing the white-box cryptography operation that includes a plurality of encoding operations, a decoding operation, and an cryptography operation on the external encoding operated plain text, and receiving the cryptogram in which the white-box cryptography operation is performed.

9. The method of claim 5, wherein the performing of the external decoding operation comprises performing, at the secure terminal, a decoding operation on the cryptogram that is acquired by performing the white-box cryptography operation that includes a plurality of encoding operations, a decoding operation, and a cryptography operation on the external encoding operated plain text.

10. An operation method performed at a secure terminal, the method comprising:
receiving an external encoding operated plain text from a user terminal;
performing a white-box cryptography operation that includes a plurality of encoding operations, a decoding operation, and a cryptography operation on the external encoding operated plain text; and
transmitting the white-box cryptography operated plain text to the user terminal, wherein the user terminal displays the white-box cryptography operated plain text.

11. The method of claim 10, wherein the external encoding operated plain text indicates a result of performing, at the user terminal, the external encoding operation on the plain text using a security table for external encoding.

12. The method of claim 10, wherein the performing of the white-box encoding operation comprises performing the white-box cryptography operation on the external encoding operated plain text using an encoding/decoding table among lookup tables for the white-box cryptography operation.
